(19) United States
(12) Patent Application Publication
(10) Pub. No.: US 2012/0058368 A1
(43) Pub. Date: Mar. 8, 2012

(54) ELECTRICAL STORAGE DEVICE

(76) Inventors: Takatoshi YAMAMOTO, Hitachi-shi (JP); Hideki Homma, Hitachinaka-shi (JP)

(21) Appl. No.: 13/197,852

(22) Filed: Aug. 4, 2011

(30) Foreign Application Priority Data
Sep. 3, 2010 (JP) 2010-197855

(51) Int. Cl. H01M 2/00; H01M 2/30; H01M 2/24; H01M 2/02

(52) U.S. Cl. 429/7; 429/159

(57) ABSTRACT

An electrical storage device includes: a battery assembly that is constituted by electrically connecting a plurality of battery cells with one another through a conductive member; a casing in which the battery assembly is housed; a control unit that is placed on an upper surface of the casing, and monitors a physical state of the plurality of battery cells; electric components that include a high-rate circuit and a low-rate circuit of the battery assembly; and a protection member that protects the electric components, wherein: an uppermost surface of the protection member and an uppermost surface of the control unit are arranged to be leveled with each other.

### INCORPORATION BY REFERENCE

The disclosure of the following priority application is herein incorporated by reference: Japanese Patent Application No. 2010-197855 filed Sep. 3, 2010.

### BACKGROUND OF THE INVENTION

1. Field of the Invention

The present invention relates to an electrical storage device which includes a plurality of storage batteries.

2. Description of Related Art

Japanese Laid Open Patent Publication No. 2000-223160 discloses an electrical storage device assuming a structure in which a plurality of battery assembly modules, each of which includes a plurality of storage batteries (battery cells) connected in series, are housed in a battery case and each battery of the battery modules is protected by a protection electronic circuit mounted to the battery case. In the electrical storage device stated in Japanese Laid Open Patent Publication No. 2000-223160, in order to detect voltage at each of the battery modules, a voltage detection bus bar is constituted by connecting the protection electronic circuit through a fuse to a bus bar connecting battery modules and the voltage detection bus bar is insert molded to a side plate.

### SUMMARY OF THE INVENTION

While the upper surface of the electrical storage device stated in the above publication is usually mounted with a connector for power input/output, a control unit for managing and controlling the electrical storage device, and the like, the upper surfaces of these devices are not necessarily leveled and therefore load from above may act locally.

An electrical storage device according to a first aspect of the present invention, comprises: a battery assembly that is constituted by electrically connecting a plurality of battery cells with one another through a conductive member; a casing in which the battery assembly is housed; a control unit that is placed on an upper surface of the casing, and monitors a physical state of the plurality of battery cells; electric components that include a high-rate circuit and a low-rate circuit of the battery assembly; and a protection member that protects the electric components, wherein: an uppermost surface of the protection member and an uppermost surface of the control unit are arranged to be leveled with each other.

According to a second aspect of the present invention, in the electrical storage device according to the first aspect, it is preferable that the electric components include positive and negative external terminals that are connected to positive and negative terminals of the battery assembly, respectively, and that protrude to an upper surface of the casing, and a connection terminal to which a voltage detection conductor that detects voltage at the battery cells is connected, and that protrudes to an upper surface of the casing.

According to a third aspect of the present invention, in the electrical storage device according to the second aspect, it is preferable that the protection member is a terminal block that covers the positive and negative external terminals.

According to a fourth aspect of the present invention, in the electrical storage device according to the second aspect, the protection member may be a harness guard that protects a harness connecting the connection terminal with the control unit.

According to a fifth aspect of the present invention, in the electrical storage device according to the second aspect, the protection member may be a supporting protrusion that erects from the casing around the connection terminal.

According to a sixth aspect of the present invention, in the electrical storage device according to the second aspect, it is preferable that a terminal block that covers the positive and negative external terminals, a harness guard that protects a harness connecting the connection terminal with the control unit, and a supporting protrusion which erects from the casing around the connection terminal are provided as the protection member.

According to a seventh aspect of the present invention, in the electrical storage device according to the second aspect, it is preferable that the casing includes a pair of side plates that faces each other, an upper plate that forms an upper surface between the pair of side plates, and a lower plate that forms a lower surface between the pair of side plates; the pair of side plates, the upper plate and the lower plate form a housing space in which the plurality of battery cells are housed, with the plurality of battery cells being juxtaposed in a longitudinal direction of the casing; and the connection terminal and the positive and negative external terminals are provided on and protrude from upper surfaces of the side plates.

According to an eighth aspect of the present invention, in the electrical storage device according to the seventh aspect, the connection terminal and the positive and negative external terminals may be provided across the control unit in a longitudinal direction of the casing.

According to a ninth aspect of the present invention, the electrical storage device according to the first aspect may further comprise a plurality of battery blocks each including the battery assembly and the casing, wherein: the control unit is fixed to an upper surface of the casing across the plurality of battery blocks so as to fix the plurality of battery blocks with one another.

An electrical storage device according to a tenth aspect of the present invention comprises: first and second battery blocks each including a battery assembly constituted by electrically connecting a plurality of battery cells with one another through a conductive member and a casing in which the battery assembly is housed, with the first and second battery blocks being juxtaposed to each other; and a control unit, placed astride on a center of upper surfaces of the casings of the first and second battery blocks, that monitors a physical state of the plurality of battery cells, wherein: each of the upper surfaces of the casings of the first and second battery blocks is provided with first and second female threads axisymmetrically with respect to a central axis of the casing at one end in a longitudinal direction of the casing and a third female thread eccentrically across a width of the casing from the central axis at an other end in the longitudinal direction of the casing; first stud is screwed to the second female thread at the first battery block, a second stud is screwed to the first female thread at the second battery block, and third studs are screwed to the third female threads at the first and second battery blocks; the control unit is provided with a first mounting section, a second mounting section, and third mounting sections through which the first stud, the second, and the third studs pass, respectively; the first stud of the first battery block passes through the first mounting section and is screwed with a nut, the second stud of the second battery block passes through the second mounting section and is screwed with a nut, and the third studs of the first and second battery blocks pass through the third mounting sections and are screwed with nuts; and the first mounting section and the second mounting section are disposed at symmetrical positions across a boundary between the first and second battery blocks, and the third mounting sections are disposed at asymmetrical positions across the boundary between the first and second battery blocks.

According to an eleventh aspect of the present invention, in the electrical storage device according to the tenth aspect, it is preferable that each of the first and second battery blocks further includes a connection terminal to which a voltage detection conductor that detects voltage at the battery cells and that protrudes from an upper surface of the casing, and positive and negative external terminals that are connected to positive and negative terminals of the battery assembly, respectively, and that protrude from the upper surface of the casing.

According to a twelfth aspect of the present invention, the electrical storage device according to the eleventh aspect may further comprise: a regulation member that regulates a position in which a harness connecting the connection terminal with a control unit is routed on the upper surface of the casing, wherein: the regulation member is fixed with the second female thread in the first battery block, and the regulation member is fixed with the first female thread in the second battery block.

### BRIEF DESCRIPTION OF THE DRAWINGS

FIG. 1 is a block diagram showing an embodiment of a vehicle-mounted electric machine system in which an electrical storage device according to the present invention is used.

FIG. 2 is a perspective view showing an external structure of the electrical storage device of FIG. 1.

FIG. 3 is a perspective view of the electrical storage device of FIG. 2, seen from a cooling medium inlet side.

FIG. 4 is a perspective view showing a battery block in the electrical storage device of FIG. 2.

FIG. 5 is an exploded perspective view of the battery block shown in FIG. 4.

FIG. 6 is a front view of the electrical storage device of FIG. 2, seen from the cooling medium inlet side.

FIG. 7 is a top view of the cooling medium inlet side of the electrical storage device of FIG. 2, in which harnesses are not illustrated.

FIG. 8 is a view showing a voltage detection conductor in the electrical storage device of FIG. 2.

### DESCRIPTION OF PREFERRED EMBODIMENTS

An embodiment of an electrical storage device according to the present invention will now be explained with reference to the drawings.

### Embodiments

The present embodiment is an example in which the present invention is applied to an electrical storage device constituting a vehicle-mounted power source system for an electric powered vehicle, in particular an electric vehicle. An electric vehicle includes a hybrid electric vehicle that has both an internal combustion engine and an electric machine as a driving source of the vehicle and a pure electric vehicle that has an electric machine as an only driving source of the vehicle.

In this description, the explanation assumes that the electrical storage device is constituted with a battery module and a control unit, the battery module is constituted with a plurality of battery blocks and each of the plurality of battery blocks is constituted by housing into a casing a battery assembly in which a plurality of battery cells are connected.

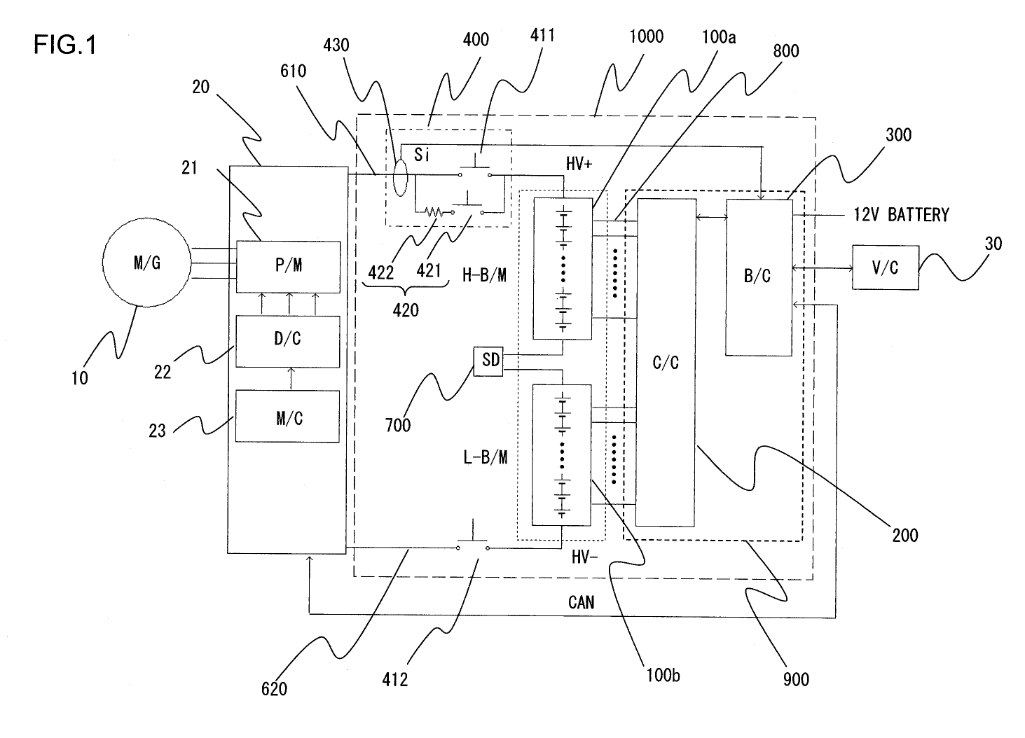

The structure of the vehicle-mounted electric machine system (electrical machine driving system) including the electrical storage device according to an embodiment will be explained with reference to FIG. 1.

### —Vehicle-Mounted Electric Machine System—

The vehicle-mounted electric machine system includes a motor generator 10, an inverter device 20, a vehicle controller 30 which controls the entire vehicle, an electrical storage device 1000 which constitutes a vehicle-mounted power source device, and the like. The electrical storage device 1000 includes a plurality of storage batteries and is constituted as, for example, a lithium ion battery device which includes a plurality of lithium ion battery cells.

(Motor Generator)

The motor generator 10 is a three-phase AC synchronous machine. In an operating mode requiring rotational power such as during power running of the vehicle or starting the internal combustion engine, the motor generator 10 drives the motor and supplies the generated rotational power to driven bodies such as wheels and the engine. In this case, the vehicle-mounted electric machine system converts DC power into three-phase AC power and supplies it from the lithium ion battery device 1000 to the motor generator 10 via the inverter device 20, which is an electric power conversion device.

In an operating mode requiring power generation, for instance, during regeneration such as decelerating or braking the vehicle or when the lithium ion battery device 1000 needs to be recharged, the motor generator 10 is driven on drive power from the wheels or the engine and works as a generator to generate three-phase AC power. In this case, the vehicle-mounted electric machine system converts the three-phase AC power from the motor generator 10 into DC power via the inverter device 20 and supplies it to the lithium ion battery device 1000. As a result, electric power is accumulated in the lithium ion battery device 1000.

(Inverter Device 20)

The inverter device 20 is an electronic circuit device which controls the power conversion described above, i.e., conversion from DC power to three-phase AC power and from three-phase AC power to DC power, upon the operation (ON/OFF) of a switching semiconductor device. The inverter device 20 includes a power module 21, a driver circuit 22, and a motor controller 23.

The power module 21 is a power conversion circuit which includes six switching semiconductor devices to perform the power conversion described above upon the switching operation (ON/OFF) of the six switching semiconductor devices.

A metal-oxide semiconductor field-effect transistor (MOSFET) or an insulated gate bipolar transistor (IGBT), for instance, is used for the switching semiconductor devices. In the power module 21 constituted with a MOSFET, parasitic diodes are electrically connected in inverse parallel between a drain electrode and a source electrode. In the power module 21 constituted with an IGBT, on the other hand, it is separately required to electrically connect diodes in inverse parallel between a collector and an emitter.

The power module 21 is constituted with a three-phase bridge circuit, in which series circuits (an arm for one phase), each of which includes two (an upper arm and a lower arm) switching semiconductor devices electrically connected in series, are electrically connected in parallel for three phases.

The power module 21 is provided with a DC positive-side module terminal (not shown in the figures) and a DC negative-side module terminal (not shown in the figures), and the side of each upper arm opposite to the lower arm connection side is electrically connected to the DC positive-side module terminal, and the side of each lower arm opposite to the upper arm connection side is electrically connected to the DC negative-side module terminal. The DC positive-side module terminal and the DC negative-side module terminal are electrically connected to a DC positive-side external terminal and a DC negative-side external terminal, respectively. The DC positive-side external terminal and the DC negative-side external terminal are power source-side terminals to transfer DC power to and from the lithium ion battery device 1000 and electrically connected with power cables 610 and 620 extending from the lithium ion battery device 1000.

In addition, the power module 21 is provided with an AC-side module terminal, and the AC-side module terminal is electrically connected to an AC-side external terminal. The AC-side external terminal is a load-side terminal to transfer three-phase AC power to and from the motor generator 10 and electrically connected with a load cable extending from the motor generator 10.

(Motor Controller 23)

The motor controller 23 is an electronic circuit device to control the switching operation of the six switching semiconductor devices constituting the power module 21. Based upon a torque command having been output from a higher-order control unit, e.g., the vehicle controller 30, which controls the whole vehicle, the motor controller 23 generates a switching operation command signal (for example, PWM (pulse width modulation) signal) to the six switching semiconductor devices. The generated command signal is output to the driver circuit 22.

Based upon the switching operation command signal having been output from the motor controller 23, the driver circuit 22 generates a drive signal to the six switching semiconductor devices constituting the power module 21. This drive signal is output to a gate electrode of the six switching semiconductor devices constituting the power module 21. As a result, switching (ON/OFF) of the six switching semiconductor devices constituting the power module 21 is controlled based upon the drive signal having been output from the driver circuit 22.

The electrical storage device, i.e., the lithium ion battery device 1000 includes a battery module 100 to accumulate and release electrical energy (charge and discharge DC power) and a control unit 900 to manage and control the state of the battery module 100.

The battery module 100 is constituted with two battery blocks (or battery packs), i.e., a high potential-side battery block 100a and a low potential-side battery block 100b which are electrically connected in series.

In addition, the power module 21 is provided with the AC-side module terminal, and the AC-side module terminal is electrically connected to the AC-side external terminal. The AC-side external terminal is a load-side terminal to transfer three-phase AC power to and from the motor generator 10 and electrically connected with the load cable extending from the motor generator 10.

The cell controller 200, constituted with a plurality of integrated circuits (IC), is, so to speak, a slave circuit of the battery controller 300, which manages and controls the state of the plurality of lithium ion battery cells 140 according to a command from the battery controller 300. The management and control of the state of the plurality of lithium ion battery cells 140 include measurement of the voltage at each of the lithium ion battery cells 140, adjustment of the stored charge at each of the lithium ion battery cells 140, and the like. Each of the integrated circuits is designated to a plurality of corresponding lithium ion battery cells 140, and manages and controls the state of the plurality of corresponding lithium ion battery cells 140.

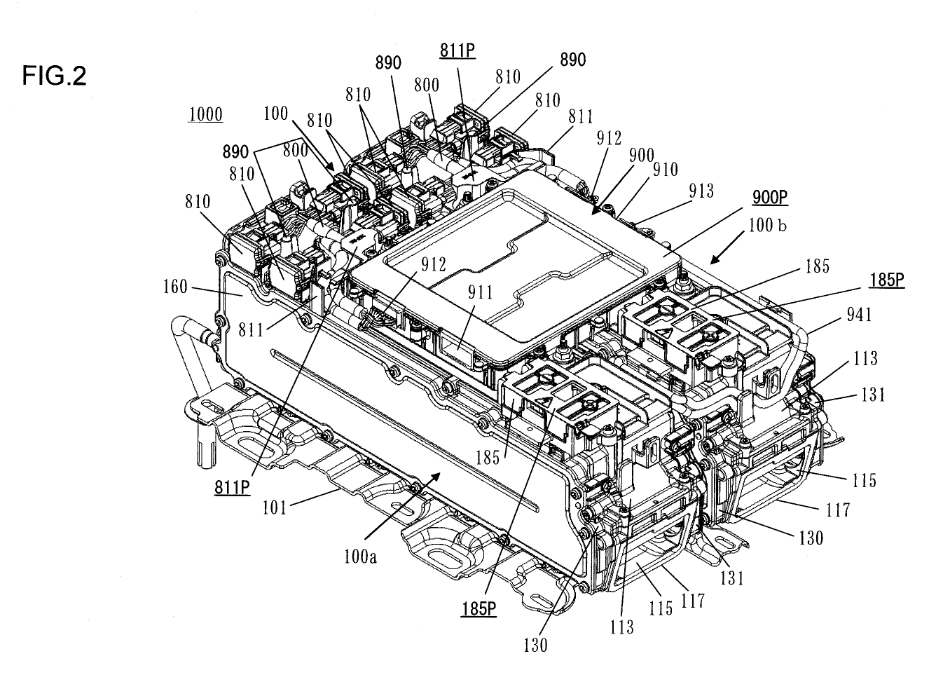

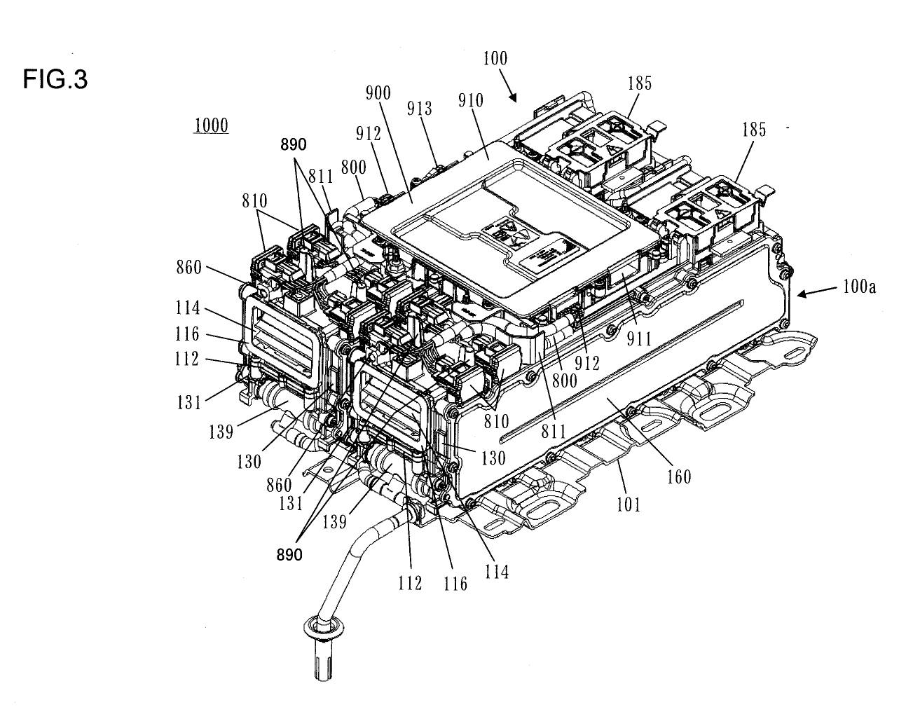

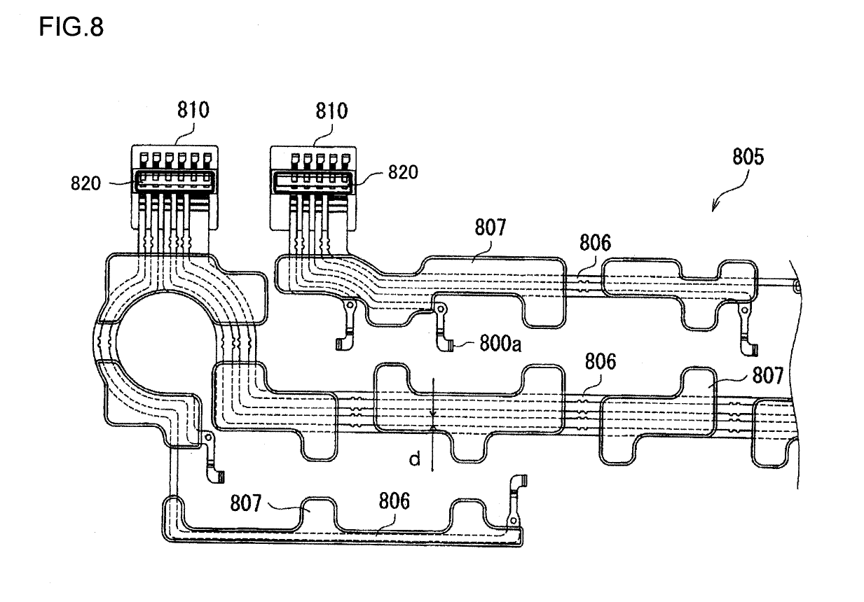

The plurality of corresponding lithium ion battery cells 140 are used as a power source of the integrated circuits constituting the cell controller 200. For this purpose, the cell controller 200 and the battery module 100 are electrically connected with each other through a connection line 800 (FIG. 2, FIG. 3, and FIG. 8). Voltage of the highest potential at the plurality of corresponding lithium ion battery cells 140 is applied to each of the integrated circuits through the connection line 800.

A positive terminal of the high potential-side battery block 100a and the DC positive-side external terminal of the inverter device 20 are electrically connected with each other through the positive-side power cable 610. A negative terminal of the low potential-side battery block and the DC negative-side external terminal of the inverter device 20 are electrically connected with each other through the negative-side power cable 620.

A junction box 400 and a negative-side main relay 412 are provided in the power cables 610 and 620. A relay mechanism constituted with a positive-side main relay 410 and a precharge circuit 420 is housed inside the junction box 400. The relay mechanism is an open/close section to allow electrical conduction and block between the battery module 100 and the inverter device 20. More specifically, the relay mechanism allows conduction between the battery module 100 and the inverter device 20 when starting up the vehicle-mounted electrical machine system and it blocks conduction between the battery module 100 and the inverter device 20 when stopping or in the event of an abnormality of the vehicle-mounted electrical machine system. The relay mechanism thus controls between the lithium ion battery device 1000 and the inverter device 20 so as to ensure a high level of safety of the vehicle-mounted electrical machine system.

The relay mechanism is driven and controlled by the motor controller 23. Upon reception of a notification of start-up completion of the lithium ion battery device 1000 from the battery controller 300 when starting up the vehicle-mounted electrical machine system, the motor controller 23 outputs a conduction command signal to the relay mechanism so as to drive the relay mechanism. In addition, upon reception of an OFF output signal from an ignition key switch when stopping the vehicle-mounted electrical machine system, or upon reception of an abnormality signal from the vehicle controller in the event of an abnormality of the vehicle-mounted electrical machine system, the motor controller 23 outputs a block command signal to the relay mechanism so as to drive the relay mechanism.

The positive-side main relay 411 is provided in the positive-side power cable 610 and controls electrical connection between the positive side of the lithium ion battery device 1000 and the positive side of the inverter device 20. The negative-side main relay 412 is provided in the negative-side power cable 620 and controls electrical connection between the negative side of the lithium ion battery device 1000 and the negative side of the inverter device 20.

The precharge circuit 420 is a series circuit in which a precharge relay 421 and a resistor 422 are electrically connected in series, and is electrically connected in parallel to the positive-side main relay 411.

When starting up the vehicle-mounted electrical machine system, the negative-side main relay 412 is firstly turned on and the precharge relay 421 is then turned on. As a result, the current having been supplied from the lithium ion battery device 1000 is regulated by the resistor 422 and is then supplied to the smoothing capacitor 24 and charged. After the smoothing capacitor is charged up to a predetermined voltage, the positive-side main relay 411 is turned on and the precharge relay 421 is released. As a result, the main current is supplied from the lithium ion battery device 1000 to the inverter device 20 through the positive-side main relay 411.

An ammeter 430 is housed inside the junction box 400. The ammeter 430 is provided in order to detect current supplied from the lithium ion battery device 1000 to the inverter device 20. An output line of the ammeter 430 is electrically connected to the battery controller 300. Based upon a signal having been output from the ammeter 430, the battery controller 300 detects the current supplied from the lithium ion battery device 1000 to the inverter device 20. The current detection information is notified from the battery controller 300 to the motor controller 23, the vehicle controller 30, and the like.

The ammeter 430 may be provided outside the junction box 400. In addition, a current detection section of the lithium ion battery device 1000 may not be on the inverter device 20 side of the positive-side main relay 411 but be on the battery module 100 side of the positive-side main relay 411.

It is to be noted that a voltmeter for detecting the voltage at the lithium ion battery device 1000 may be housed inside the junction box 400. The battery controller 300 detects the overall voltage at the lithium ion battery device 1000 based upon an output signal from the voltmeter. The voltage detection information is notified to the motor controller 23 and the vehicle controller 30. A voltage detection section of the lithium ion battery device 1000 may be provided on any of the battery module 100 side and the inverter device 20 side of the relay mechanism.

### —Lithium Ion Battery Device—

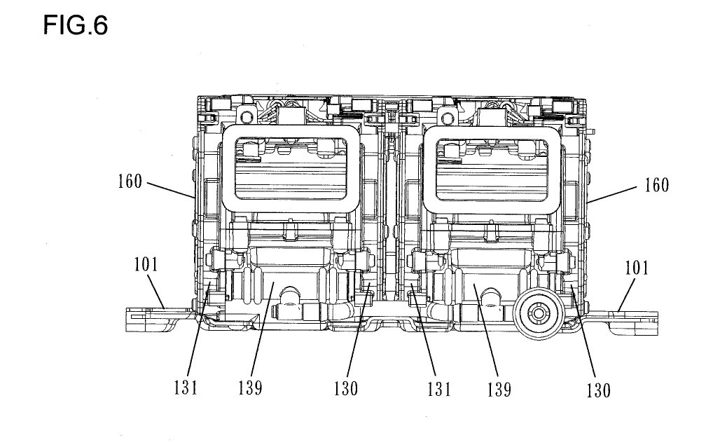

Next, the structure of the lithium ion battery device 1000 will be explained with reference to FIG. 2 to FIG. 7.

The lithium ion battery device 1000 is constituted with two main units, i.e., the battery module 100 and the control unit 900.

(Battery Module)

The structure of the battery module 100 will now be explained.

As described earlier, the battery module 100 is constituted with the high potential-side battery block 100a and the low potential-side battery block 100b, and the two battery blocks 100a and 100b are electrically connected in series. It is to be noted that the high potential-side battery block 100a and the low potential-side battery block 100b include exactly the same structure.

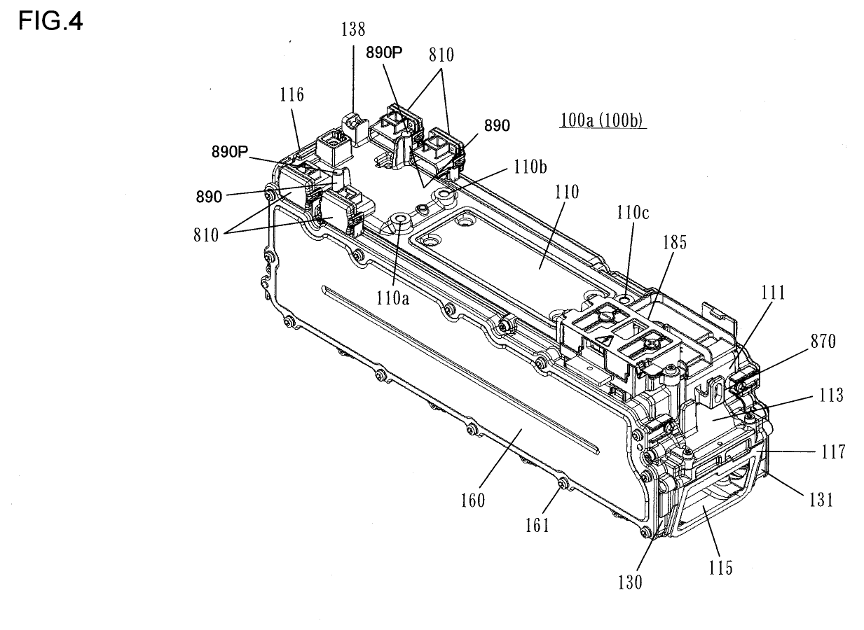

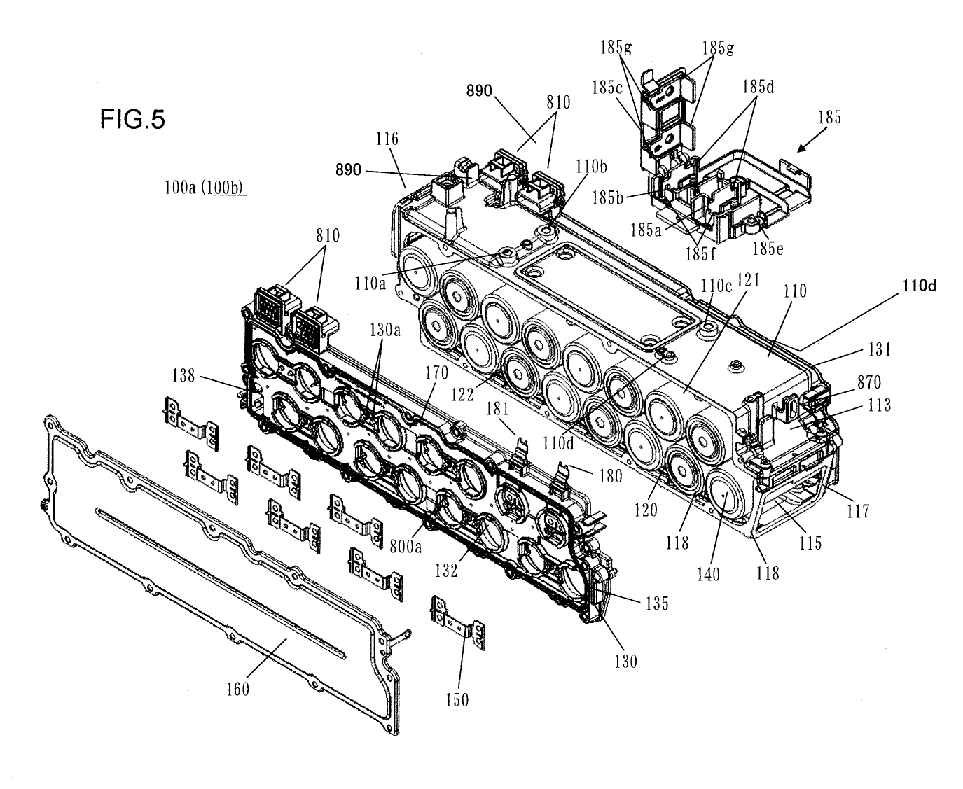

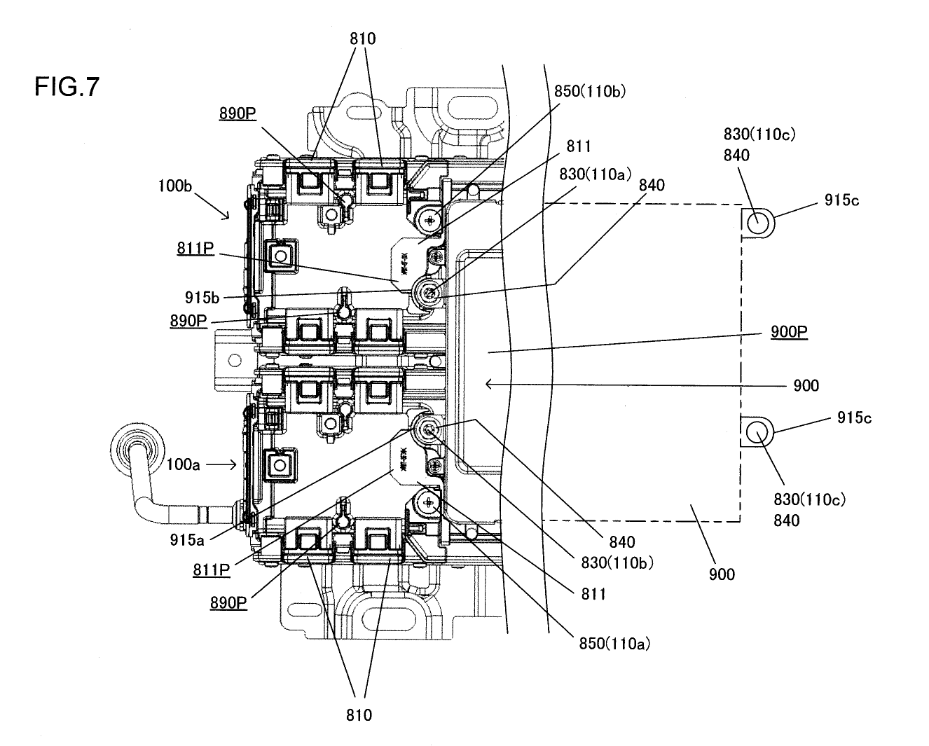

For this reason, FIG. 4, FIG. 5, and FIG. 7 present only the high potential-side battery block 100a as a representative example of the high potential-side battery block 100a and the low potential-side battery block 100b, and an explanation of the detailed structure of the low potential-side battery block 100b will be curtailed.

As shown in FIG. 2 and FIG. 3, the high potential-side battery block 100a and the low potential-side battery block 100b are adjacently arranged in parallel with each other so that longitudinal directions of each of the blocks are in parallel. The high potential-side battery block 100a and the low potential-side battery block 100b are juxtaposed on a module base 101 and fixed with a fixing means such as a bolt. The module base 101 is constituted with a rigid, thin-wall metal plate (a steel plate, for example) which is divided into three in a transverse direction and fixed to the vehicle. In other words, the module base 101 is constituted with three members placed transversely on the both ends and the center.

By adopting this structure, the surface of the module base 101 can be flush with the lower surface of each of the battery blocks 100a and 100b, thereby contributing to reduction in dimension of the battery module 100 in the height direction.

The upper portion of the high potential-side battery block 100a and the low potential-side battery block 100b is fixed with a case 910 of a control device 900 described later.

As shown in FIG. 2 to FIG. 7, in particular FIG. 4, FIG. 5, and FIG. 7, the high potential-side battery block 100a is mainly constituted with a casing 110 (may be referred to as a case, a housing, or a package) and a battery assembly 120. The battery assembly 120 is housed and held inside the casing 110.

The casing 110 is a substantially hexahedral block case, which is constituted with a combination of six members, i.e., an inlet channel forming plate 111, an outlet channel forming plate 118, an inlet-side guide plate 112, an outlet-side guide plate 113, and two side plates 130 and 131. The interior space of the casing 110 functions as a housing chamber in which the battery assembly 120 is housed and also functions as a cooling channel through which a cooling medium (cooling air) flows to cool down the battery assembly 120.

It is to be noted that in the explanation provided below, a direction with the longest dimension of the casing 110 and a direction from the cooling medium inlet 114 side to the cooling medium outlet 115 side are defined as a longitudinal direction. In addition, a direction in which two side surfaces (the two side plates 130 and 131), which are different from the two side surfaces (the inlet-side guide plate 112 and the outlet-side guide plate 113) which face each other in the longitudinal direction of the casing 110, face each other, a central axial direction of the lithium ion battery cells 140 (a direction in which two electrodes. i.e., the positive terminal and the negative terminal, face each other), and a direction in which a conductive member (bus bar) 150, which electrically connects two of the lithium ion battery cells 140, and two of the lithium ion battery cells 140 face each other are defined as a transverse direction. In addition, a direction in which the inlet channel forming plate 111 and the outlet channel forming plate 118 face each other is defined as a height direction regardless of the installation orientation of the battery module 100.

The inlet channel forming plate 111 is a rectangular flat plate that forms the top surface of the casing 110. The outlet channel forming plate 118 is a flat plate that forms the bottom surface of the casing 110. The inlet channel forming plate 111 and the outlet channel forming plate 118 are displaced in the longitudinal direction at the positions of the longitudinal end portions with respect to each other. The inlet channel forming plate 111 and the outlet channel forming plate 118 are formed of rigid, thin-wall metal plates.

The inlet-side guide plate 112 is a plate-like member which forms one side of the side surfaces facing the longitudinal direction of the casing 110. The outlet-side guide plate 113 is a plate-like member which forms the other side of the side surfaces facing the longitudinal direction of the casing 110. The inlet-side guide plate 112 and the outlet-side guide plate 113 are formed of rigid, thin-wall metal plates.

The cooling medium inlet 114, which constitutes an inlet via which cooling air, i.e., a cooling medium, is led into the casing 110, is formed between the inlet channel forming plate 111 and the inlet-side guide plate 112. The cooling medium inlet 114 is provided with a cooling medium inlet duct 116 to lead cooling air to the cooling medium inlet 114. As described above, the inlet channel forming plate 111 and the outlet channel forming plate 118 are displaced with respect to each other, and the inlet-side end of the casing 110 is formed in steps. The cooling medium outlet 115, which constitutes an outlet via which cooling air is led from inside the casing 110, is formed between the outlet channel forming plate 118 and the outlet-side guide plate 113. The cooling medium outlet 115 is provided with a cooling medium outlet duct 117 to lead cooling air through the cooling medium outlet 115 to outside.

The cooling medium inlet 114 and the cooling medium outlet 115 are displaced with respect to each other in the height direction (the direction in which the inlet channel forming plate 111 and the outlet channel forming plate 118 face each other). In other words, the cooling medium inlet 114 is positioned on the inlet channel forming plate 111 side, and the cooling medium outlet 115 is positioned on the outlet channel forming plate 118 side.

For the purpose of better assembling efficiency of the battery blocks, the inlet channel forming plate 111, the outlet-side guide plate 113, the cooling medium inlet 114, and the cooling medium inlet duct 116 are integrally formed, and the outlet channel forming plate 118, the inlet-side guide plate 112, the cooling medium outlet 115, and the cooling medium outlet duct 117 are integrally formed.

The inlet channel forming plate 111, the outlet-side guide plate 113, the cooling medium inlet 114, and the cooling medium inlet duct 116, which are integrally formed, and the outlet channel forming plate 118, the inlet-side guide plate 112, the cooling medium outlet 115, and the cooling medium outlet duct 117, which are similarly integrally formed, are formed by mold casting with metal. Therefore, since they have greater thickness than that of a case formed by bending sheet-metal, they have greater strength against external load and impact and, since they have greater dimensional accuracy in screw holes and cutting surface than that by sheet-metal working, they exhibit great assemblability with other components.

The inlet channel forming plate 111, the outlet channel forming plate 118, the inlet-side guide plate 112, the outlet-side guide plate 113, the cooling medium inlet 114, and the cooling medium outlet 115, and the side plates 130 and 131 are connected by fixing means (not shown in the figures) such as screws, bolts, or rivets. A sealing member (not shown in the figures) is provided between those connection members so as to improve air-tightness inside the casing 110 and to allow the cooling medium having been led inside the casing 110 through the cooling medium inlet 114 to be discharged through the cooling medium outlet 115 without leaking out.

The side plates 130 and 131, flat plate-like members which form two side surfaces facing in the transverse direction of the casing 110, are moldings made of a resin such as PBT, which has electrical insulation properties. The wall thicknesses of the side plates 130 and 131 are greater than those of the inlet channel forming plate 111, the outlet channel forming plate 118, the inlet-side guide plate 112, and the outlet-side guide plate 113. The detailed structure of the side plates 130 and 131 will be described later.

A cover member 160, which is referred to as a side cover, is provided outside the side plates 130 and 131, i.e., on the opposite side of the housing chamber of the battery assembly 120. While only the cover member 160 provided outside the side plate 130 is illustrated in FIG. 5, the cover member 160 is provided outside the side plate 131 as well. The cover member 160 is fixed to the side plate 130 with a fixing means (not shown in the figures) such as bolts or rivets.

The cover member 160 is a flat plate prepared by pressing a metal plate of steel, aluminium, or the like, or a flat plate prepared by molding a resin of PBT or the like, and assumes the structure of substantially the same shape of that of the planar shape of the side plate 130. The cover member 160 has a region which includes a section corresponding to a through-hole 132 of the side plate 160 described later, with the region evenly bulging towards the opposite side of the side plate 130.

As a result, a space is formed between the cover plate 160 and the side plate 130. This space functions as a gas discharge channel 138 through which mist gas having been emitted from the lithium ion battery cells 140 is released separately from the cooling medium flowing through the cooling channel.

An opening section of the gas discharge channel 138 is formed on a lower part of the side plate 130 for the purpose of discharge of fluid such as electrolytic solution included in the gas. More specifically, the opening section is formed on the cooling medium inlet 140 side of the side plate 130 and the side plate 130 on the outlet channel forming plate 118 side. A front end section of the gas discharge channel 138 is formed in a pipe-like shape, to which a gas outlet pipe 139 (refer to FIG. 3) through which the gas having been discharged through the gas discharge channel 138 is led out is connected.

Thus, the casing 110 includes the pair of facing side plates 130 and 131, the upper plate 111 forming the upper surface between the pair of side plates 130 and 131, and the lower plate 118 forming the lower surface between the pair of side plates 130 and 131, and the housing space in which the plurality of battery cells 140 are housed is formed with these members.

(Battery Assembly)

The battery assembly 120 is an assembly (lithium ion battery cell group) of the plurality of lithium ion battery cells 140. The plurality of lithium ion battery cells 140 are aligned and housed in the housing chamber formed inside the casing 110, sandwiched by the side plates 130 and 131 from the transverse direction, and electrically connected in series by joining the plurality of conductive members called bus bars.

The lithium ion battery cells 140 assume a structure in columnar shape, constituted with component parts such as a cell element and a safety valve which are housed inside a battery case in which electrolytic solution has been injected.

As shown in FIG. 5 in particular, in the present embodiment, the battery assembly 120 is constituted by aligning and disposing sixteen of the cylindrical lithium ion battery cells 140 inside the casing 110. More specifically, in a state in which the lithium ion battery cells 140 are placed on their sides so that the central axes of the lithium ion battery cells 140 extend along the transverse direction, eight of the lithium ion battery cells 140 are disposed in parallel so as to constitute a first battery cell array 121. In addition, similar to the first battery cell array 121, the other eight of the lithium ion battery cells 140 are disposed so as to constitute a second battery cell array 122. The battery assembly 120 is constituted by layering (stacking or header bond) the first battery cell array 121 and the second battery cell array 122 in the height direction.

In other words, the battery assembly 120 is constituted by arranging eight arrays of the lithium ion battery cells 140 in the longitudinal direction and two stacks or two layers thereof in the height direction.

The first battery cell array 121 and the second battery cell array 122 are displaced with respect to each other in the longitudinal direction. More specifically, the first battery cell array 121 is disposed closer to the inlet channel forming plate 111 side than the second battery cell array 122 is, and displaced towards the cooling medium inlet 114 side. On the other hand, the second battery cell array 122 is disposed closer to the outlet channel forming plate side than the first battery cell array 121 is, and displaced towards the cooling medium outlet 115 side.

The first battery cell array 121 and the second battery cell array 122 are displaced with respect to each other in the longitudinal direction so that, for example, the longitudinal position of the central axis of one of the lithium ion battery cells 140 lying closest to the cooling medium outlet 115 in the first battery cell array 121 lies in the middle between the central axis of one of the lithium ion battery cells 140 lying closest to the cooling medium outlet 115 in the second battery cell array 122 and the central axis of one of the lithium ion battery cells 140, which is adjacent thereto.

The lithium ion battery cells 140 constituting the first battery cell array 121 are juxtaposed so as to alternate the directions of the terminals thereof. The lithium ion battery cells 140 constituting the second battery cell array 122 are similarly juxtaposed so as to alternate the directions of the terminals thereof.

However, the sequence from the cooling medium inlet 114 side to the cooling medium outlet 115 side of the terminals of the lithium ion battery cells 140 constituting the first battery cell array 121 is different from that of the terminals of the lithium ion battery cells 140 constituting the second battery cell array 122. More specifically, in the first battery cell array 121, the lithium ion battery cells 140 are disposed so that the terminals thereof facing the side plate 130 side are arranged in order of the negative terminal, the positive terminal, the negative terminal, . . . , and the positive terminal from the cooling medium inlet 114 side to the cooling medium outlet 115 side. In the second battery cell array 122, on the other hand, the lithium ion battery cells 140 are disposed so that the terminals thereof facing the side plate 130 side are arranged in order of the positive terminal, the negative terminal, the positive terminal, . . . , and the negative terminal from the cooling medium inlet 114 side to the cooling medium outlet 115 side.

In this manner, by disposing the first battery cell array 121 and the second battery cell array 122 displaced in the longitudinal direction, the battery assembly 120 can be reduced in dimension in the height direction and the high potential-side battery block 110a can thus be reduced in size in the height direction.

(Side Plates)

Next, the structure of the side plates 130 and 131 sandwiching the battery assembly 120 from both sides will be explained in detail. While, for better understanding, only the structure of the side plate 130 of one side will now be explained, the side plate 131 is configured basically the same as the side plate 130.

However, a battery module side connection terminal 180, electrically connected to the positive side of the battery assembly 120, and a battery module side connection terminal 181, electrically connected to the negative side of the battery assembly 120, are provided only on the side plate 130. The connection terminals 180 and 181 are aligned longitudinally on the upper surface of the side plate 130, i.e., on the surface of the inlet channel forming plate 111 side. A DC positive-side input/output terminal 185a and a negative-side input/output terminal 185b, which are provided on a terminal block 185 having been prepared as a subassembly separately from the battery module 100, are connected to the connection terminals 180 and 181, respectively.

As shown in FIG. 5, the terminal block 185 is prepared in advance as a block in which the terminals 185a and 185b, stud bolts 185d, and a collar 185e are inserted. The terminal block 185 is mounted with an openable/closable cover 185c for short circuit protection and the safety.

The terminal block 185, which is a substantially rectangular solid in a state in which the cover 185c is closed, is disposed in parallel to the transverse direction closer to the cooling medium outlet 115 side than the control unit 900 is.

The connection terminals 180 and 181, which are provided on the side plates, are welded to the positive-side input terminal 185a and the negative-side input terminal 185b, which are provided on the terminal block 185, respectively. At this time, the terminals contact each other on the surfaces, with the outside being sandwiched by electrodes. For this reason, the terminal block 185 is provided with four notches 185f so as to ensure a space into which the electrodes are put. After welding, the four notches 185f are covered by protruding portions 185g of the cover 185c in order to prevent a finger or a foreign object from getting into through the notches 185f, thereby ensuring safety.

The cover 185c of the terminal block 185 protects the external connection terminals 180 and 181 protruding from the side plates 130 and 131 against load from above.

As shown in FIG. 5, sixteen round through-holes 132 bored through in the transverse direction are formed on the side plate 130 which is shaped into a substantially rectangular flat plate. The through-holes 132 are disposed so as to open corresponding to the electrode positions of the sixteen lithium ion battery cells 140. Accordingly, when the battery assembly 120 is housed in the casing 110, each of the through-holes 132 on the side plate 130 is closed with a terminal surface on one end side of the corresponding lithium ion battery cell 140, and the through-holes 132 on the side plate 131 side are closed with a terminal surface on the other end side of the lithium ion battery cells 140.

A protruding section 135 is formed partially encompassing each through-hole 132 on an outer wall surface 170 of the side plate 130, which is the opposite side to an inner wall surface with which the housing chamber of the battery assembly 120 is formed. In addition, between the through-holes 132 of the outer wall surface 170, a plurality of fixing guides 130a are formed so as to dispose the conductive members 150 to be connected to the lithium ion battery cells 140. The protruding section 135 and the fixing guides 130a are each configured to protrude from the outer wall surface 170 so as to prevent the cover member 160 and the conductive members 150 from contacting each other. This prevents short circuit between the cover member 160 and the conductive members 150 if the cover member 160 is made of, for example, a flat metal plate such as steel.

As shown in FIGS. 4 to 7, connection terminals 810 are provided in the longitudinal direction on the upper surface of the side plate 130, i.e., on the surface of the inlet channel forming plate 111 side. The connection terminals 810 are integrally formed on the side plate 130 with the same forming material as that of the side plate 130, and disposed on the upper surface of the side plate 130 on the cooling medium inlet 114 side. As shown in FIG. 8, each of the connection terminals 810 is a signal pick-up terminal of a voltage detection conductor 805 (FIG. 8). The connection terminals 810 are provided with a connector via which the connection line 800 is connected and a connector at the front end of the connection line 800 is connected to a connector 912 of the control unit 900.

The voltage detection conductor 805 will be explained with reference to FIG. 8. In order to downsize the side plate 130 and thus downsize the overall battery module 100, the shape of the voltage detection conductor 805 is designed so as to effectively use an available space of the side plate 130. In addition, since the plurality of lithium ion battery cells 140 are connected in series via the conductive members 150, potential difference occurs among the plurality of conductive members 150 to which the voltage detection conductor 805 is connected. Therefore, in the voltage detection conductor 805, arrangement of detection lines 806 is determined so as to minimize the potential difference between the adjacent detection lines 806. It is to be noted that a numeral 800a represents the front end of the voltage detection conductor 805, and the front end 800a is welded to the conductive members 150.

After being formed into a predetermined shape by pressing or the like, the voltage detection conductor 805 is fixed in shape by a resin section 807 made of the same resin as that of, for example, the side plate 130. More specifically, the voltage detection conductor 805 is fixed so that the plurality of detection lines 806 are each separated by the resin section 807 and the shape of each of the detection lines 806 is maintained. The voltage detection conductor 805 is constituted with, for instance, two sub-units in which the detection lines 806 are fixed by the resin section 807 at a plurality of positions. As shown in FIG. 8, each of the sub-units is provided with the external terminal 810 through which a signal is transferred to outside.

The voltage detection conductor 805 fixed with the resin section 807 is integrally formed with the side plate 130 by, for example, insert molding with the resin constituting the side plate 130. This allows the connection terminals 810 to be provided on the upper surfaces of the side plates 130 and 131 in a protruding manner as shown in FIG. 5. Since the detection lines 806 are fixed so as to be separated from each other, the short circuit does not substantially occur in the detection lines 806 when the voltage detection conductor 805 is integrally formed with the side plate 130.

The voltage detection conductor 805, which is thus resin-molded to the side plate 130, is connected from the connection terminals 810 to the voltage detection connector 912 through the connection line 800. The voltage detection connector 912 is provided at each end of the control unit 900 in the transverse direction. The connection line 800 connected to the connection terminals 810 provided on the high potential-side battery block 100a is connected to the connector 912 disposed above the high potential-side battery block 100a of the control unit 900. On the other hand, the connection line 800 connected to the connection terminals 810 provided on the low potential-side battery block 100b is connected to the connector 912 disposed above the low potential-side battery block 100b of the control unit 900.

In order to prevent erroneous wiring, the length of the connection line 800 is set to be equivalent to the distance between each of the connection terminals 810 and the corresponding connector 912. For example, the length of the connection line 800 connected to the connection terminals 810 of the high potential-side battery block 100a is set not to reach the connector 912 for the low potential-side battery block 100b. A current block section 820 includes a fuse wire which is fused when an abnormality occurs in the control circuit 900 and the line 800 so as to block current from the battery assembly 120, thereby protecting the product.

In the connection line 800, a multitude of harnesses are partly bundled with insulation protection members, and as described later, wiring route of the multitude of harnesses is regulated, i.e., guided by harness guards 811 and protected against load from above.

The control device 900 is placed on the battery module 100. More specifically, the control device 900 is an electronic circuit device placed across the high potential battery module 100a and the low potential battery module 100b and includes the case 910 and a circuit board housed inside the case 910.

The case 910 is a flat, cuboid-shaped metal box body, which is fixed to the high potential-side battery block 100a and the low potential-side battery block 100b with a fixing means such as bolts or screws. As a result, the high potential-side battery block 100a and the low potential-side battery block 100b are fixed via the control device 900 connecting the transverse ends between the battery blocks. In other words, the control device 900 functions as a supporting and reinforcing member, which can improve the strength of the battery module 100.

A plurality of electronic components (not shown in the figures) and a plurality of connectors 911, 912, and 913 are connected to the upper surface of the circuit board by soldering. Those connectors include the voltage detection connector 912, a temperature detection connector 913, and a connector 911 for external connection, and the like.

The voltage detection connector 912 is coupled with a connector of the connection line 800 electrically connected to the thirty-two lithium ion battery cells 140. The temperature detection connector 913 is coupled with a connector (not shown in the figures) of a signal line of a plurality of temperature sensors (not shown in the figures) disposed inside the battery module 100.

The connector 911 for external connection is coupled with connectors (not shown in the figures) of a power source line through which drive power source is supplied to the battery controller 300, a signal line through which an ON/Off signal of the ignition key switch is input, a communication line through which controller area network (CAN) communication with the vehicle controller 30 and the motor controller 23 is performed, and the like.

The connection line 800 connected to the connection terminals 810 provided on the high potential-side battery block 100a is connected to the connector 912 disposed above the high potential-side battery block 100a of the control unit 900. On the other hand, the connection line 800 connected to the connection terminals 810 provided on the low potential-side battery block 100b is connected to the connector 912 disposed above the low potential-side battery block 100b of the control unit 900.

As described earlier, the low potential-side battery block 100b has the same structure as that of the high potential-side battery block 100a.

As shown in FIG. 4 and FIG. 5, female threads 110b, 110c, and 110d are formed on the inlet channel forming plate 111, and a female thread 110a, and the female threads 110b and 110c are used for mounting the control unit 900. The female thread 110d is used to mount the terminal block 185.

As shown in FIG. 7, the control unit 900 spanning over the high potential-side battery block 100a and the low potential-side battery block 100b is fixed by screwing nuts 840 onto stud bolts 830 screwed to the female threads 110b and 110c on the high potential-side battery block 100a side and passing through boss sections of the control unit 900 and onto stud bolts 830 screwed to the female threads 110a and 110c on the low potential-side battery block 100b side and passing through the boss sections of the control unit.

Here, the female threads 110a and 110b are arranged symmetrically with respect to the central line along the flow direction of cooling air of the inlet channel forming plate 111. As a result, even if wrong assembly of some components occurs on the assembly line, as described later, reassembly can be carried out in a short period of time in a small number of assembly steps. This not only allows the degrees of freedom in the assembly work to be increased but also allows response to human errors to be made easier.

As shown in FIG. 2, FIG. 3, and FIG. 7, the inlet channel forming plate 111 is provided with the pair of harness guards 811 mounted closer to the cooling medium inlet 114 than the control unit 900 is. The harness guards 811, which are to hold and fix the wiring (connection line) 800 extending from the voltage detection connectors 912 to the connection terminals 810, are formed into an open channel bent in two steps in a staircase pattern with synthetic resin.

In the high potential-side battery block 100a, the harness guard 811 is fixed onto the upper surface of the inlet channel forming plate 111 with a screw 850 to be screwed to the female thread 110a, whilst in the low potential-side battery block 100b, the harness guard 811 is fixed onto the upper surface of the inlet channel forming plate 111 with the screw 850 to be screwed to the female thread 110b. The harness guard 811 used for the high potential-side battery block 100a and the harness guard 811 used for the low potential-side battery block 100b are prepared in a symmetrically opposite manner.

As shown in FIG. 2 and FIG. 7, uppermost surfaces 811P of the harness guards 811, an uppermost surface 900P of the control unit 900, uppermost surfaces 185P of the terminal blocks 185a and 185b, and upper surfaces 890P of four strengthening protrusions 890 erecting from the inlet channel forming plate 111 at the ends of the cooling medium inlet duct 116 side are set in a substantially same height. In short, in the electrical storage device according to the present embodiment, the same-leveled supporting surfaces 811P, 900P, 185P, and 890P are formed above the inlet channel forming plate 111. Those supporting surfaces bear dispersed load from above on their entire surfaces, thereby improving the strength and the impact resistance of the electrical storage device.

The casing 110 is provided with pairs of hooked members 860 and 870 at the both longitudinal ends so as to hang hooks (not shown in the figures), so that the electrical storage device can be hooked and supported when shipping the electrical storage device and the like. When the electrical storage device is unpacked from a packaging material, the hooked members 860 and 870 allow the electrical storage device to be hooked and taken out even if a hand or a jig can not reach the bottom of the electrical storage device.

(Wrong Assembly of Battery Blocks and Modification Work)

On the assembly line, there are prepared as many battery blocks in which the stud bolts 830 are screwed to each of the female threads 110b and the female threads 110c as battery blocks in which the stud bolts 830 are screwed to each of the female threads 110a and the female threads 110c. The former are for high potential battery blocks and the latter are for low potential battery blocks. These battery blocks are fixed to the base plate 101 and then the control unit 900 is fixed across the high potential battery block 100a and the low potential battery block 100b. At this time, the two types of battery blocks 100a and 100b may possibly be fixed to the base plate 101 inversely to the intended arrangement. If such wrong assembly occurs, the battery blocks are to be removed from the base plate 101 and to be reassembled in the correct arrangement. However, such modification work is significantly inefficient.

Then, for instance, if the stud 830 has been mounted to the female thread 110a of a battery block on the side which is intended to be provided with the high potential battery block, this stud 830 is to be removed and screwed again to the female thread 110b. On the other hand, if the stud 830 has been mounted to the female thread 110b of a battery block on the side which is intended to be provided with the low potential battery block, this stud 830 is to be removed and screwed again to the female thread 110a. Thus, with a work to modify the mounting position of the stud alone, the control unit 900 can be fixed across the two battery blocks 100a and 100b and the period of time required for the modification work can be reduced.

Wrong assembly can be modified with such ease due to the following reasons, which will be explained with reference to FIG. 7 in particular.

In the electrical storage device of the embodiment, the upper surface of the casing 110 of each of the battery blocks 100a and 100b is provided with the first and second female threads 110a and 110b axisymmetrically with respect to the casing central axis at one longitudinal end of the casing 110. The third female thread 110c is provided eccentrically across the width of the casing from the central axis at the other longitudinal end of the casing 110. The first to third studs 830 are screwed to the second female thread 110b of the first battery block 100a, the first female thread 110a of the second battery block 100b, and the third female threads 110c of the first and second battery blocks 100a and 100b, respectively. The control unit 900 is provided with first to third mounting sections 915a to 915c through which the first to third studs 830 pass. The first stud 830 of the first battery block 100a passes through the first mounting section 915a and screwed with the nut 840, the second stud 830 of the second battery block 100b passes through the second mounting section 915b and screwed with the nut 840, and the third studs 830 of the first and second battery blocks 100a and 100b pass through the third mounting sections 915c and screwed with the nuts 840. The first mounting section 915a and the second mounting section 915b are provided at symmetrical positions across the boundary between the first and second battery blocks 100a and 100b. The third mounting sections 915c are provided at asymmetrical positions across the boundary between the first and second battery blocks 100a and 100b.

Since the first female thread 110a and the second female thread 110b are thus arranged symmetrically with respect to the longitudinal axis central line of the casing 110, even if a battery block prepared for high potential and a battery block prepared for low potential are wrongly placed on the base plate 101, modification can be performed with ease simply by replacing the studs 830.

In addition, the harness guard 811 is attached using the first female thread 110a in the high potential battery block 100a and the harness guard 811 is attached using the second female thread 110b in the low potential battery block 100b. Since the mounting screws of the harness guards 811 are arranged to be the same in size as the mounting screws of the control unit 900, one type of battery block can be used as either the high potential-side battery block 100a or the low potential-side battery block 100b.

Since one type of battery block is thus used as either the high potential or low potential-side battery block 100a or 100b, wrong assembly as described earlier may occur. For this reason, the control unit mounting structure described above is adopted so as to simplify the wrong assembly modification work.

[Variations]

The above explanation is merely an example, and the present invention is not to be limited to the above embodiments. Therefore, the present invention can be applied to a variety of electrical storage devices which include the battery assembly 120, which is constituted by electrically connecting the plurality of battery cells 140 with one another through conductive member 150, the casing 110, in which the battery assembly 120 is housed, the control unit 900, which is placed on the upper surface of the casing 110 so as to monitor a physical state of the plurality of battery cells 140, electric components including a high-rate circuit and a low-rate circuit of the battery assembly 120, and a protection member which protects the electric components. In this case, the uppermost surface of the protection member and the uppermost surface 900P of the control unit 900 are arranged to be leveled.

In addition, the voltage detection conductors 805, which detect voltage at the battery cells 140, are connected as an electric component to the connection terminals 810 protruding to the upper surface of the casing 110 and the positive and negative terminals of the battery assembly 120, and may include the positive and negative external terminals 180 and 181 protruding to the upper surface of the casing 110. In this case, the electrical storage device is configured so that the uppermost surface of the protection members which protect electric components such as the terminal block 185, the harness guard 811, and the supporting protrusion 890 and the uppermost surface 900P of the control unit 900 are leveled.

While in the above embodiment, the terminal block 185, which covers the positive and negative external terminals 180 and 181, the harness guard 811, which protects the harness 800 connecting the connection terminal 810 with the control unit 900, and the supporting protrusion 890, which erects from the casing 110 around the connection terminal 810, are provided as protection members, any one or combination of any two of those protection members may be adopted.

In addition, the present invention can be applied to an electrical storage device which is constituted with one battery block and an electrical storage device which is constituted with three or more battery blocks.

In the above embodiment, the battery module 100, which is constituted with the two battery blocks 100a and 100b, in which the sixteen lithium ion battery cells 140 are connected, is presented as an example. However, the present invention is not to be limited to the above-described configuration and connection methods (serial and parallel) of the battery module 100, and the present invention is to be applied to a configuration with the various number of the lithium ion battery cells 140, the various number of the battery cell arrays, and various alignments and directions.

While in the above embodiment, a cylindrical cell is presented as an example of the lithium ion battery cell 140, the present invention is not to be limited thereto. The present invention is to be applied also to a battery with the lithium ion battery cell 140 of the shape of, for instance, a prismatic storage cell or laminate sealed cell and in addition, the present invention is to be applied also to a battery such as a nickel-metal hydride battery other than a lithium ion battery cell.

The electrical storage device 1000 according to the above embodiment may be used in a vehicle power source system for another electric vehicle, for instance, a train vehicle such as a hybrid train, a public transport vehicle such as a bus, a freight vehicle such as a truck, and a work vehicle such as a battery forklift truck.

The electrical storage device 1000 according to the above embodiment may be applied to an electrical storage device which constitutes a power source system other than an electric vehicle, such as an uninterruptible power source system used in a computer system, a server system, and the like and a power source system used in household power generation equipment.

According to the above embodiment, the upper surface of the protection member which protects the electric components of the battery block and the upper surface of the control unit are configured to be leveled. As a result, a variety of loads applied from above the electrical storage device are dispersed and borne by the control unit and the protection member. Consequently, a local load does not act on the electric components and the control unit, which is advantageous in terms of strength. In addition, wrong assembly of two battery blocks can be modified with ease.

The above described embodiments are examples, and various modifications can be made without departing from the scope of the invention.

What is claimed is:

1. An electrical storage device, comprising:
a battery assembly that is constituted by electrically connecting a plurality of battery cells with one another through a conductive member;
a casing in which the battery assembly is housed;
a control unit that is placed on an upper surface of the casing, and monitors a physical state of the plurality of battery cells;
electric components that include a high-rate circuit and a low-rate circuit of the battery assembly; and
a protection member that protects the electric components, wherein:
an uppermost surface of the protection member and an uppermost surface of the control unit are arranged to be leveled with each other.

2. An electrical storage device according to claim 1, wherein:
the electric components include positive and negative external terminals that are connected to positive and negative terminals of the battery assembly, respectively, and that protrude to an upper surface of the casing, and a connection terminal to which a voltage detection conductor that detects voltage at the battery cells is connected, and that protrudes to an upper surface of the casing.

3. An electrical storage device according to claim 2, wherein:
the protection member is a terminal block that covers the positive and negative external terminals.

4. An electrical storage device according to claim 2, wherein:
the protection member is a harness guard that protects a harness connecting the connection terminal with the control unit.

5. An electrical storage device according to claim 2, wherein:
the protection member is a supporting protrusion that erects from the casing around the connection terminal.

6. An electrical storage device according to claim 2, wherein:
a terminal block that covers the positive and negative external terminals, a harness guard that protects a harness connecting the connection terminal with the control unit, and a supporting protrusion which erects from the casing around the connection terminal are provided as the protection member.

7. An electrical storage device according to claim 2, wherein:
the casing includes a pair of side plates that faces each other, an upper plate that forms an upper surface between the pair of side plates, and a lower plate that forms a lower surface between the pair of side plates;
the pair of side plates, the upper plate and the lower plate form a housing space in which the plurality of battery cells are housed, with the plurality of battery cells being juxtaposed in a longitudinal direction of the casing; and
the connection terminal and the positive and negative external terminals are provided on and protrude from upper surfaces of the side plates.

8. An electrical storage device according to claim 7, wherein:
the connection terminal and the positive and negative external terminals are provided across the control unit in a longitudinal direction of the casing.

9. An electrical storage device according to claim 1, comprising:
a plurality of battery blocks each including the battery assembly and the casing, wherein:
the control unit is fixed to an upper surface of the casing across the plurality of battery blocks so as to fix the plurality of battery blocks with one another.

10. An electrical storage device, comprising:
first and second battery blocks each including a battery assembly constituted by electrically connecting a plurality of battery cells with one another through a conductive member and a casing in which the battery assembly is housed, with the first and second battery blocks being juxtaposed to each other; and
a control unit, placed astride on a center of upper surfaces of the casings of the first and second battery blocks, that monitors a physical state of the plurality of battery cells, wherein:
each of the upper surfaces of the casings of the first and second battery blocks is provided with first and second female threads axisymmetrically with respect to a central axis of the casing at one end in a longitudinal direction of the casing and a third female thread eccentrically across a width of the casing from the central axis at an other end in the longitudinal direction of the casing;
first stud is screwed to the second female thread at the first battery block, a second stud is screwed to the first female thread at the second battery block, and third studs are screwed to the third female threads at the first and second battery blocks;
the control unit is provided with a first mounting section, a second mounting section, and third mounting sections through which the first stud, the second, and the third studs pass, respectively;
the first stud of the first battery block passes through the first mounting section and is screwed with a nut, the second stud of the second battery block passes through the second mounting section and is screwed with a nut, and the third studs of the first and second battery blocks pass through the third mounting sections and are screwed with nuts; and
the first mounting section and the second mounting section are disposed at symmetrical positions across a boundary between the first and second battery blocks, and the third mounting sections are disposed at asymmetrical positions across the boundary between the first and second battery blocks.

11. An electrical storage device according to claim 10, wherein:
each of the first and second battery blocks further includes a connection terminal to which a voltage detection conductor that detects voltage at the battery cells and that protrudes from an upper surface of the casing, and positive and negative external terminals that are connected to positive and negative terminals of the battery assembly, respectively, and that protrude from the upper surface of the casing.

12. An electrical storage device according to claim 11, further comprising:
a regulation member that regulates a position in which a harness connecting the connection terminal with a control unit is routed on the upper surface of the casing, wherein:
the regulation member is fixed with the second female thread in the first battery block, and the regulation member is fixed with the first female thread in the second battery block.
